(19) United States
(12) Patent Application Publication
(10) Pub. No.: US 2012/0089274 A1
(43) Pub. Date: Apr. 12, 2012

(54) ELECTRONIC DEVICE AND METHOD FOR CONTROLLING UNMANNED AERIAL VEHICLE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/110,927

(22) Filed: May 19, 2011

(30) Foreign Application Priority Data
Oct. 6, 2010 (TW) 99133936

(51) Int. Cl. G05D 1/00; B64C 13/20

(52) U.S. Cl. 701/2

(57) ABSTRACT

An electronic device for controlling an unmanned aerial vehicle (UAV) displays a portion of a 3D virtual scene of a monitored area of the UAV on a screen, and displays a representation icon of the UAV on a preset position of the screen. The electronic device further converts an operation signal to a control signal, and sends the control signal to control movements of the UAV. After receiving flight data from the UAV, the electronic device recognizes movements of the UAV according to the flight data, and determines adjustments to the portion of the 3D virtual scene, to control displaying of the 3D virtual scene based on the recognized movements while maintaining the representation icon of the UAV on the preset position and maintaining a direction the user presumed to be viewing the 3D virtual scene the same as a flight orientation of the UAV.

### BACKGROUND

1. Technical Field

Embodiments of the present disclosure relate to helicopter control technology, and particularly to an electronic device and method for controlling an unmanned aerial vehicle (UAV) using the electronic device.

2. Description of Related Art

UAVs have been used to perform security surveillance by capturing images of a number of monitored areas, and sending the captured images to a monitoring computer. However, a flight status of the UAV needs to be changed using a special controller installed with the monitoring computer. That is to say, if an administrator wants to change the flight status of the UAV, the administrator has to go back to the monitoring computer, and send control signals to the UAV according to the captured images. This method is inefficient to control the UAV because it is difficult to determine the current flight orientation of the UAV based on the captured images due to the UAV may change the flight orientation frequently.

### BRIEF DESCRIPTION OF THE DRAWINGS

FIG. 1 is a block diagram of one embodiment of an electronic device.

FIG. 2 is a block diagram of one embodiment of an unmanned aerial vehicle (UAV).

FIG. 3 is a block diagram of one embodiment of function modules of a UAV control unit of the electronic device in FIG. 1.

FIG. 4 is a block diagram of one embodiment of a screen of the electronic device in FIG. 1.

FIG. 5 is a block diagram of one embodiment of an operation region on the screen of FIG. 4.

FIG. 6A and FIG. 6B are a flowchart of one embodiment of a method for controlling the UAV using the electronic device in FIG. 1.

FIG. 7 and FIG. 8 are example illustrating three-dimensional virtual scene of a monitored area displayed on a region of the screen in FIG. 4.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

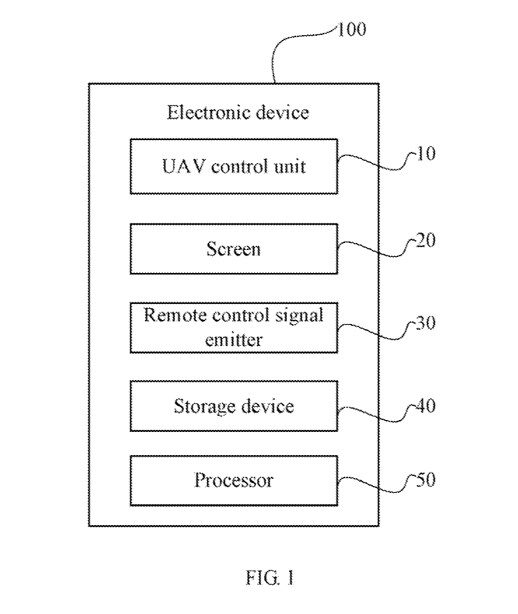

FIG. 1 is a block diagram of one embodiment of an electronic device 100. In one embodiment, the electronic device 100 includes an unmanned aerial vehicle (UAV) control unit 10, a screen 20, a remote control signal emitter 30, a storage device 40, and a processor 50. Depending on the embodiment, the electronic device 100 may be a mobile phone, a personal digital assistant, a hand-held video game machine, or other suitable devices. The screen 20 is a touch-sensitive display.

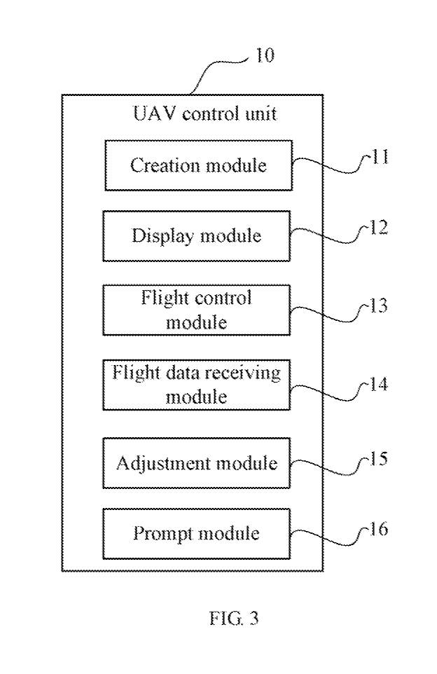

The UAV control unit 10 includes a plurality of function modules (as shown in FIG. 3), which are operable to display a three-dimensional (3D) virtual scene of a area monitored by a UAV 200 (hereinafter “the monitored area”) on the screen 20, send control signals to the UAV 200 to control movements of the UAV 20, receive flight data from the UAV 200, and determine adjustments to the 3D virtual scene according to the flight data, to make sure that a direction a user presumed to be viewing the 3D virtual scene stays the same as flight orientation of the UAV 200, so that the user can intuitively control the movements of the UAV 200 based on the received flight data and the 3D virtual scene displayed on the screen 20. A detailed description will be given in the following paragraphs.

The remote control signal emitter 30 sends the control signals to the UAV 200. The function modules of the UAV control unit 10 may comprise computerized code in the form of one or more programs that are stored in the storage device 40. The computerized code includes instructions that are executed by the processor 40 to provide above-mentioned functions of the UAV control unit 10. Depending on the embodiment, the storage device 40 may be a smart media card, a secure digital card, or a compact flash card.

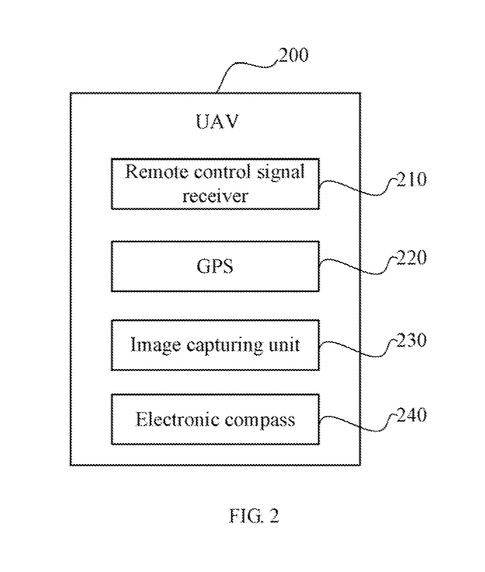

FIG. 2 is a block diagram of one embodiment of the UAV 200. In one embodiment, the UAV 20 includes a remote control signal receiver 210, a global position system (GPS) 220, an image capturing unit 230, and an electronic compass 240. The remote control signal receiver 210 receives the control signals sent from the electronic device 100. The GPS 220 detects a flight height, and altitude and longitude coordinates of the UAV 200. The image capturing unit 230 captures real time images of the monitored area. In one embodiment, the image capturing unit 230 may be a digital camera. The electronic compass 240 is configured to detect a flight orientation of UAV 200. The electronic compass 240, unlike a common compass, has a magneto resistive transducer that is distinct from a magnetic needle of a common compass. Because of Lorentz force of the magneto resistive transducer, the electronic compass 240 can calculate a voltage variation of a point charge, and determine the orientation of the UAV 200 according to the voltage variation.

FIG. 3 is a block diagram of one embodiment of function modules of the UAV control unit 10. In one embodiment, the UAV control unit 10 includes a creation module 11, a display module 12, a flight control module 13, a flight data receiving module 14, an adjustment module 15, and a prompt module 16.

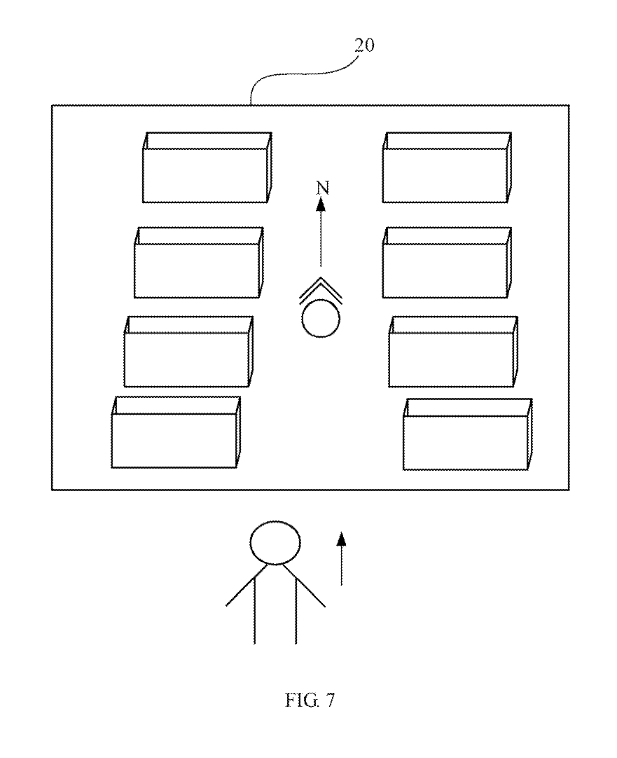

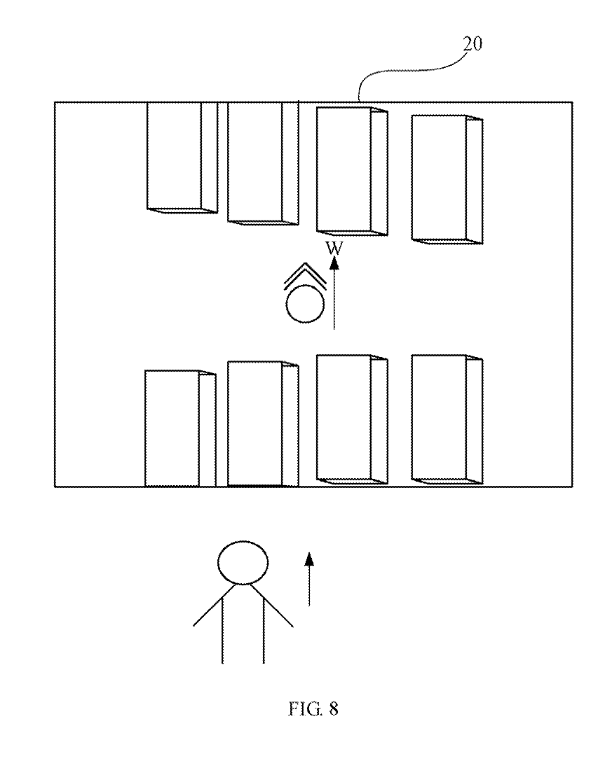

The creation module 11 is operable to create the 3D virtual scene of the monitored area and a representation icon of the UAV 200. Unlike the captured real time images of the monitored area, the 3D virtual scene of the monitored area may be created using 3D model creation tool, such as Blender, 3D MAX, or Maya. In one embodiment, as shown in FIG. 7 and FIG. 8, the 3D virtual scene of the monitored area includes a plurality of containers, the representation icon of the UAV 200 consists of a circle and a double-headed arrow.

The display module 12 is operable to display a portion of the 3D virtual scene of the monitored area on a 3D scene region 21 of the screen 20, and display the representation icon of the UAV 200 on a preset position of the 3D scene region 21. As shown in FIG. 7, is the portion of the 3D virtual scene of the monitored area, the representation icon of the UAV 200 is displayed on the center of the 3D scene region 21. A scene (such as an image or a 3D model) may not be easy to view clearly if sized to fit the 3D scene region 21, so that the 3D virtual scene of the monitored area cannot be completely displayed on the 3D scene region 21. Therefore, the display module 11 only displays a portion of the 3D virtual scene on the 3D scene region 21.

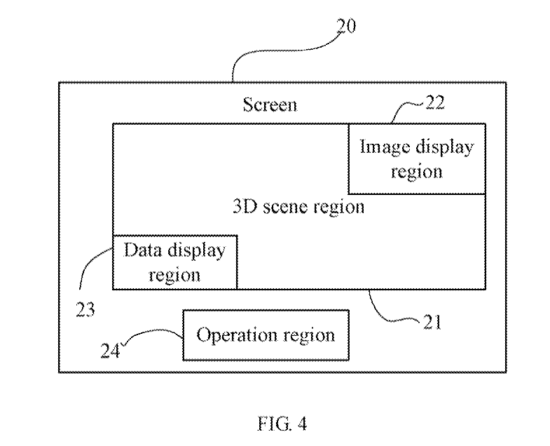

As shown in FIG. 4, the screen 20 includes a plurality of regions, such as the 3D scene region 21, an image display region 22, a data display region 23, and an operation region 24. The image display region 22 is defined to display the real time image of the monitored area. The data display region 23 is defined to display the flight data, such as the flight height, and altitude and longitude coordinates of the UAV 200. The operation region 24 is defined to receive operation signals from the user. It should be understood that, the sizes and positions of the regions 21-24 shown in FIG. 4 are just an example. In other embodiments, the 3D scene region 21 may occupy the full screen 20, and the regions 22-24 may be parts of the 3D scene region 21.

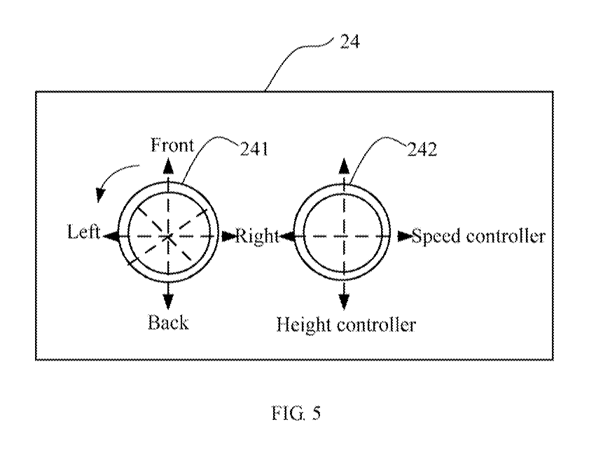

The flight control module 13 is operable to convert an operation signal received by the operation region 24 to a control signal, and send the control signal to the UAV 200 via the remote control signal emitter 30. As shown in FIG. 5, the operation region 24 displays a direction controller icon 241, and a height and speed controller icon 242. The direction controller icon 241 includes four arrows which represents “Front”, “Back”, “Left”, and “Right”. The user may adjust the flight orientation of the UAV 200 by operating the direction controller icon 241. For example, if the current flight orientation of the UAV 200 is north (as shown in FIG. 7), and the user wants to change the current flight orientation to be west (as shown in FIG. 8), the user's finger may slide from “Front” to “Left”, then the flight control module 13 converts the slide operation to a control signal of adjusting the flight orientation from north to west.

The height and speed controller icon 242 includes two vertical axes, such as a horizontal axis representing a speed controller icon and a vertical axis representing a height controller icon as shown in FIG. 5. The user may adjust a flight height of the UAV 200 by operating the height controller icon, and adjust a flight speed of the UAV 200 by operating the speed controller icon. For example, a downward slide on the height controller icon may decrease the flight height of the UAV 200, and an upward slide on the height controller icon may increase the flight height of the UAV 200. If A leftward slide on the speed controller icon may decrease the flight speed of the UAV 200, and a rightward slide on the speed controller icon may increase the flight speed of the UAV 200.

The flight data receiving module 14 is operable to receive the flight data sent from the UAV 200. As mentioned above, the flight data includes the flight height, the altitude and longitude coordinates of the UAV 200, and a real time image captured by the UAV 200.

The display module 12 is further operable to display the flight data on corresponding display regions. For example, the flight height, the altitude and longitude coordinates of the UAV 200 are displayed on the data display region 23, and the real time image is displayed on the image display region 22.

The adjustment module 15 is operable to recognize movements of the UAV 200 according to the flight data, and determine adjustments to the portion of the 3D virtual scene, to control displaying of the 3D virtual scene based on the recognized movements while maintaining the representation icon of the UAV 200 on the preset position of the 3D scene region 21 and maintaining the direction the user presumed to be viewing the 3D virtual scene the same as the flight orientation of the UAV 200. The adjustments include a movement direction and a display direction of the portion of the 3D virtual scene. For example, as shown in FIG. 7, if the adjustment module 15 determines that the UAV 200 keeps flying along north according to the flight data, the adjustment module 15 may pan the portion of the 3D virtual scene downwards along the 3D scene region 21 accordingly, to display a different portion of the 3D virtual scene while the representation icon of the UAV keeps on the center of the 3D scene region 21. If the adjustment module 15 determines that the UAV 200 changes the flight orientation according to the flight data, such as the UAV 200 changes to fly from north to west, the adjustment module 15 may first rotate the portion of the 3D virtual scene shown in FIG. 7 rightwards by 90 degrees, so that the direction the user presumed to be viewing the 3D virtual scene stays the same as the flight orientation of the UAV 200 (as shown in FIG. 8), then the adjustment module 15 may pan the portion of the 3D virtual scene downwards along the 3D scene region 21 accordingly.

Based on above-mentioned adjustments, from view of the user who views the 3D virtual scene displayed on the screen 20, the representation icon of the UAV 200 keeps stationary, while the 3D virtual scene displayed on the screen 20 appears to be just like the user is on the UAV 200.

The prompt module 16 is operable to prompt the user to send a new control signal via the electronic device 100 if an abnormity appears in the real time image. In this embodiment, the abnormity includes new objects (such as people) that appear in the real time image, or edges of the monitored area appearing in the real time image. The prompt module 16 may determine whether the abnormity appears by comparing the real time image with an initial image of the monitored area. The real time image and the initial image are stored in the storage device 40. In one embodiment, the prompt module 16 may prompt the user via sound output or text displayed on the screen 20.

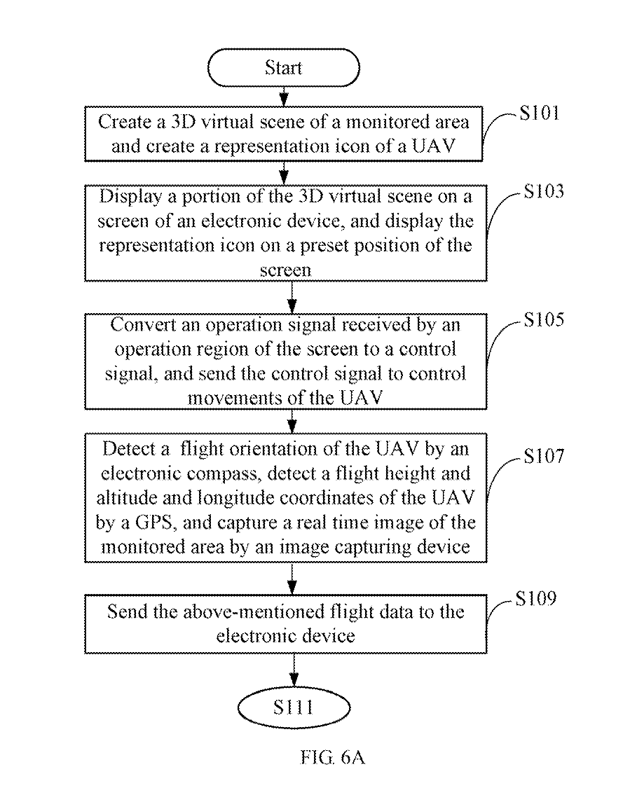

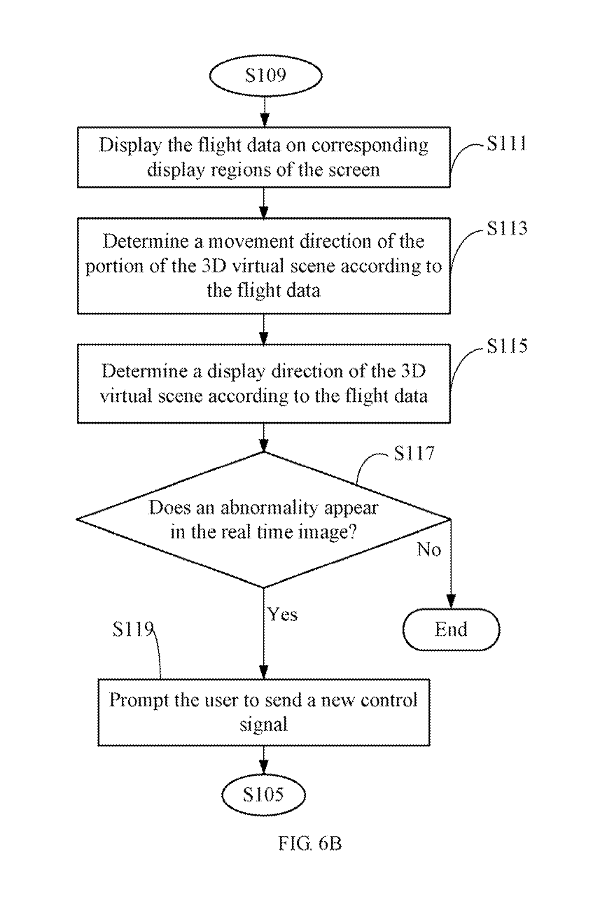

FIG. 6A and FIG. 6B are a flowchart of one embodiment of a method for controlling the UAV 200 using the electronic device 100. Depending on the embodiment, additional blocks may be added, others removed, and the ordering of the blocks may be changed.

In block S101, the creation module 11 creates a 3D virtual scene of a monitored area of the UAV 200 and a representation icon of the UAV 200. For example, the 3D virtual scene of the monitored area may be created using 3D model creation tool, such as Blender, 3D MAX, or Maya. In one embodiment, as shown in FIG. 7 and FIG. 8, the 3D virtual scene of the monitored area includes a plurality of containers, the representation icon of the UAV 200 consists of a circle and a double-head arrow.

In block S103, the display module 12 displays a portion of the 3D virtual scene of the monitored area on a 3D scene region 21 of the screen 20, and displays the representation icon of the UAV 200 on a preset position of the 3D scene region 21. As shown in FIG. 7, is the portion of the 3D virtual scene of the monitored area, the representation icon of the UAV 200 is displayed on the center of the 3D scene region 21.

In block S105, the flight control module 13 converts an operation signal received by the operation region 24 to a control signal, and sends the control signal to the UAV 200 via the remote control signal emitter 30. For example, if the current flight orientation of the UAV 200 is north (as shown in FIG. 7), and the user wants to change the current flight orientation to be west (as shown in FIG. 8), the user may slide a finger from “Front” to “Left” on the direction controller icon 241 shown on the operation region 24 of FIG. 5, then the flight control module 13 converts the slide operation to a control signal for adjusting the flight orientation from north to west.

In block S107, the UAV 200 collects flight data, such as detecting a flight orientation by the electronic compass 240, detecting a flight height and altitude and longitude coordinates by the GPS 220, and capturing a real time image of the monitored area by the image capturing unit 230.

In block S109, the UAV 200 sends the flight data to the electronic device 100.

In block S111, the flight data receiving module 14 receives the flight data sent from the UAV 200, and the display module 12 displays the flight data on corresponding display regions. For example, the flight height, the altitude and longitude coordinates of the UAV 200 is displayed on the data display region 23, and the real time image is displayed on the image display region 22.

In block S113, the adjustment module 15 recognizes movements of the UAV 200 according to the flight data, and determines a movement direction of the portion of the 3D virtual scene, to display a different portion of the 3D virtual scene while the representation icon of the UAV 200 keeps on the preset position of the 3D scene region 21. For example, as shown in FIG. 7, if the adjustment module 15 determines that the UAV 200 keeps flying along north according to the flight data, the adjustment module 15 may pan the portion of the 3D virtual scene downwards along the 3D scene region 21 accordingly, so that the representation icon of the UAV keeps on the center of the 3D scene region 21.

In block S115, the adjustment module 15 recognizes movements of the UAV 200 according to the flight data, and determines a display direction of the portion of the 3D virtual scene, the direction the user presumed to be viewing the 3D virtual scene stays the same as the flight orientation of the UAV 200. For example, if the adjustment module 15 determines that the UAV 200 changes the flight orientation according to the flight data, such as that the UAV 200 changes to fly from north to west, the adjustment module 15 may rotate the portion of the 3D virtual scene shown in FIG. 7 rightwards by 90 degrees, so that the direction the user presumed to be viewing the 3D virtual scene stays the same as the flight orientation of the UAV 200 (as shown in FIG. 8).

In block 5117, the prompt module 16 determines if an abnormity appears in the real time image of the monitored area by comparing the real time image with an initial image of the monitored area. If no abnormity appears in the real time image, the procedure ends. Otherwise, if an abnormity, such as a person, appears in the real time image, the procedure goes to block S119, the prompt module 16 prompts the user to send a new control signal to the UAV 200 via the screen 20, then the procedure goes to block S105.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for controlling an unmanned aerial vehicle (UAV) using an electronic device, comprising:
creating a three-dimensional (3D) virtual scene of a monitored area of the UAV and a representation icon of the UAV;
displaying a portion of the 3D virtual scene on a 3D scene region of a screen of the electronic device, and displaying the representation icon of the UAV on a preset position of the 3D scene region;
converting an operation signal received on an operation region of the screen to a control signal, and sending the control signal to the UAV;
receiving flight data sent from the UAV;
displaying the flight data on corresponding display regions of the screen; and
recognizing movements of the UAV according to the flight data, and determining adjustments to the portion of the 3D virtual scene, to control displaying of the 3D virtual scene based on the recognized movements while maintaining the representation icon of the UAV on the preset position of the 3D scene region and maintaining a direction the user presumed to be viewing the 3D virtual scene the same as a flight orientation of the UAV.

2. The method as claimed in claim 1, wherein the adjustments comprise a movement direction adjustment and a display direction adjustment of the portion of the 3D virtual scene.

3. The method as claimed in claim 1, wherein the operation region comprises a direction controller icon, a height controller icon and a speed controller icon, and wherein an operation on the direction controller icon is converted to a control signal of changing the flight orientation of the UAV, an operation on the height controller icon is converted to a control signal of changing the flight height of the UAV, and an operation on the speed controller icon is converted to a control signal of changing the flight speed of the UAV.

4. The method as claimed in claim 1, wherein the flight data comprises the flight orientation, a flight height, altitude and longitude coordinates of the UAV, and a real time image of the monitored area.

5. The method as claimed in claim 4, further comprising:
determines if an abnormity appears in the real time image of the monitored area by comparing the real time image with an initial image of the monitored area; and
prompting the user to send a new control signal to the UAV via the screen in response that an abnormity appears in the real time image.

6. The method as claimed in claim 4, wherein displaying the flight data on corresponding display regions of the screen comprising: displaying the flight height, the altitude and longitude coordinates of the UAV on a data display region of the screen, and displaying the real time image on an image display region of the screen.

7. The method as claimed in claim 1, wherein the screen is a touch-sensitive display.

8. An electronic device, comprising:
a screen;
a storage device;
a processor; and
one or more programs that are stored in the storage device and are executed by the at processor, the one or more programs comprising:
a creation module operable to create a three-dimensional (3D) virtual scene of a monitored area of an unmanned aerial vehicle (UAV) and a representation icon of the UAV;
a display module operable to display a portion of the 3D virtual scene of the monitored area on a 3D scene region of the screen, and display the representation icon of the UAV on a preset position of the 3D scene region;
a flight control module operable to convert an operation signal received on an operation region of the screen to a control signal, and send the control signal to the UAV;
a flight data receiving module operable to receive flight data sent from the UAV;
the display module further operable to display the flight data on corresponding display regions of the screen; and
an adjustment module operable to recognize movements of the UAV according to the flight data, and determine adjustments to the portion of the 3D virtual scene, to control displaying of the 3D virtual scene based on the recognized movements while maintaining the representation icon of the UAV on the preset position of the 3D scene region and maintaining a direction the user presumed to be viewing the 3D virtual scene the same as a flight orientation of the UAV.

9. The electronic device as claimed in claim 8, wherein the adjustments comprise a movement direction adjustment and a display direction adjustment of the portion of the 3D virtual scene.

10. The electronic device as claimed in claim 8, wherein the operation region comprises a direction controller icon, a height controller icon and a speed controller icon, wherein the flight control module converts an operation on the direction controller icon to a control signal of changing the flight orientation of the UAV, converts an operation on the height controller icon to a control signal of changing the flight height of the UAV, and converts an operation on the speed controller icon to a control signal of changing the flight speed of the UAV.

11. The electronic device as claimed in claim 8, wherein the flight data comprises a flight orientation, a flight height, altitude and longitude coordinates of the UAV, and a real time image of the monitored area.

12. The electronic device as claimed in claim 11, wherein the one or more programs further comprise a prompt module operable to:
determine if an abnormity appears in the real time image of the monitored area by comparing the real time image with an initial image of the monitored area; and
prompt the user to send a new control signal to the UAV via the screen in response that an abnormity appears in the real time image.

13. The electronic device as claimed in claim 11, wherein the display module displays the flight height, the altitude and longitude coordinates of the UAV on a data display region of the screen, and displays the real time image on an image display region of the screen.

14. The electronic device as claimed in claim 11, wherein the screen is a touch-sensitive display.

15. A non-transitory computer readable medium storing a set of instructions, the set of instructions capable of being executed by a processor of an electronic device to perform a method for controlling an unmanned aerial vehicle (UAV) using an electronic device, the method comprising:
creating a three-dimensional (3D) virtual scene of a monitored area of the UAV and a representation icon of the UAV;
displaying a portion of the 3D virtual scene of the monitored area on a 3D scene region of a screen of the electronic device, and displaying the representation icon of the UAV on a preset position of the 3D scene region;
converting an operation signal received on an operation region of the screen to a control signal, and sending the control signal to the UAV;
receiving flight data sent from the UAV;
displaying the flight data on corresponding display regions of the screen; and
recognizing movements of the UAV according to the flight data, and determining adjustments to the portion of the 3D virtual scene, to control displaying of the 3D virtual scene based on the recognized movements while maintaining the representation icon of the UAV on the preset position of the 3D scene region and maintaining a direction the user presumed to be viewing the 3D virtual scene the same as the flight orientation of the UAV.

16. The non-transitory computer readable medium as claimed in claim 15, wherein the adjustments comprise a movement direction adjustment and a display direction adjustment of the portion of the 3D virtual scene.

17. The non-transitory computer readable medium as claimed in claim 15, wherein the operation region comprises a direction controller icon, a height controller icon and a speed controller icon, wherein an operation on the direction controller icon is converted to a control signal of changing the flight orientation of the UAV, an operation on the height controller icon is converted to a control signal of changing the flight height of the UAV, and an operation on the speed controller icon is converted to a control signal of changing the flight speed of the UAV.

18. The non-transitory computer readable medium as claimed in claim 15, wherein the flight data comprises a flight orientation, a flight height, altitude and longitude coordinates of the UAV, and a real time image of the monitored area.

19. The non-transitory computer readable medium as claimed in claim 18, wherein the method further comprises:
determines if an abnormity appears in the real time image of the monitored area by comparing the real time image with an initial image of the monitored area; and
prompting the user to send a new control signal to the UAV via the screen in response that an abnormity appears in the real time image.

20. The non-transitory computer readable medium as claimed in claim 18, wherein displaying the flight data on corresponding display regions of the screen comprising: displaying the flight height, the altitude and longitude coordinates of the UAV on a data display region of the screen, and displaying the real time image on an image display region of the screen.
